(19) United States
(12) Patent Application Publication
(10) Pub. No.: US 2010/0099011 A1
(43) Pub. Date: Apr. 22, 2010

(54) ELECTRODE MORPHOLOGY VIA USE OF HIGH BOILING POINT CO-SOLVENTS IN ELECTRODE INKS

(75) Inventors: BRADLEY M. HOUGHTALING, Rochester, NY (US); AMIT NAYAR, Pittsford, NY (US)

Correspondence Address: DINSMORE & SHOHL LLP, FIFTH THIRD CENTER, ONE SOUTH MAIN STREET, SUITE 1300, DAYTON, OH, 45402, US

(73) Assignee: GM GLOBAL TECHNOLOGY OPERATIONS, INC., Detroit, MI (US)

(21) Appl. No.: 12/255,257

(22) Filed: Oct. 21, 2008

(51) Int. Cl. H01M 4/90; B05D 5/12; H01M 4/88

(52) U.S. Cl. 429/43; 427/77

(57) ABSTRACT

A method and device for operating a fuel cell system. The method includes applying a catalyst ink or related liquid that contains an electrocatalyst and electrolyte to a diffusion media so that the portion of the media that includes the electrocatalyst can function as a fuel cell electrode, specifically an anode or cathode. In addition to the electrocatalyst and electrolyte, the ink contains a solvent and a co-solvent, where the co-solvent has a boiling point that exceeds that of the solvent. Heating or related processing removes the solvent from the diffusion layer, but leaves at least some of the co-solvent in liquid form. This residual liquid reduces the likelihood of electrode cracking that may otherwise form during subsequent electrode processing.

### BACKGROUND OF THE INVENTION

The present invention relates generally to methods for making diffusion media for fuel cells, and more particularly to making electrodes in such a way as to reduce electrode cracking and consequent failure of a polymer membrane that is fluidly coupled to the electrode.

In a typical fuel cell configuration, an electrolyte is sandwiched between electrodes (specifically, an anode and a cathode) such that positive ions generated by a catalytic reaction at the anode flow through the electrolyte and react with negative ions that are generated by a catalytic reaction at the cathode, while current generated by the flow of free electrons produced at the anode during the oxidation of a hydrogen-bearing anode reactant and consumed at the cathode during the reduction of an oxygen-bearing cathode reactant can be used to power one or more external devices. In one type of fuel cell, called a proton exchange membrane (PEM) fuel cell, the electrolyte is a polymer-based ion exchange membrane (called an ionomer) that together with the anode and cathode form a core called a membrane electrode assembly (MEA). A diffusion layer (also referred to as diffusion media, or more particularly as a gas diffusion media (GDM)) is a fluidly porous member that is typically placed adjacent to a respective one of the anode and cathode to allow passage of gaseous reactants from their respective source to an electrochemically active catalyst (also called an electrocatalyst, which typically contains platinum or a platinum alloy, often formed on the surface of a carbon support or base) that can be placed on as a separate layer or in as an integral part of the corresponding GDM to form a catalyst coated diffusion media (CCDM) that can be placed on or in the corresponding electrode, or disposed as a layer on the diffusion media or ion-exchange membrane. As such, a GDM may be part of the CCDM that also includes an electrocatalyst and ionomer applied in liquid form onto the microporous layer of the GDM.

The diffusion media tends to be highly electrically conductive, and may also contain in particulate form an electrically conductive material to improve such conductivity. It may be made from carbon fiber paper, woven and nonwoven carbon fabrics, metal mesh or gauze, as well as other woven and nonwoven materials that give it a generally porous structure. The substrate may be pre-treated with polytetrafluoroethylene (PTFE) or a related water-repellant agent to enhance water repellency. Other treatments known to those skilled in the art, such as porosity-reducing carbon or graphite sublayers, electrocatalyst-compatible surface roughening or other approaches may also be used.

As stated above, one way to couple the electrocatalyst to the GDM in order to form the electrode is to deposit the electrocatalyst in an ink, liquid or related coating directly on the porous GDM to yield the CCDM. In one typical form, a catalyst-containing ink is applied to a fluid layer to form the CCDM then dried, after which the anode and cathode CCDMs are hot pressed along with the membrane to create a final MEA sandwich-like structure in the form of an integral diffusion media electrode. This ink-based manufacturing approach to creating a CCDM is easier and less expensive to perform than approaches employing separate discreet layers that are subsequently affixed to one another.

Unfortunately, such a manufacturing approach can cause the electrodes to become highly cracked (also referred to as mud cracked). Such mud cracked electrodes lead to a higher incidence of membrane failure during subsequent operation in a fuel cell. Without being bound to a particular theory as to the cause of such mud cracking, the present inventors believe that one potential cause is that mud cracking frequently occurs during the drying of colloidal dispersions where, during the drying process of a coated film, significant stresses are generated and often manifest themselves as mud cracks. The initiation of the cracks is commonly due to the lack of cohesive strength of the film, thus as the film strives to relieve itself of the stress, it often creates cracks.

Accordingly, it would be desirable to develop a way to manufacture the electrodes and diffusion media of a fuel cell that minimizes the likelihood of electrode cracking and concomitant membrane failure. It is also desirable to manufacture the electrode and diffusion media in such a way as to keep fuel cell manufacturing costs low.

### BRIEF SUMMARY OF THE INVENTION

These desires are met by the present invention, wherein a fuel cell and methods of making the system in such a way as to avoid the problems of the prior art is disclosed. In accordance with a first aspect of the present invention, a method of preparing an electrode assembly for a fuel cell is disclosed. The method includes applying a catalyst ink (that is made up of at least an electrocatalyst material, ionomer electrolyte, a solvent (which may include, among other, water) and a co-solvent) to a diffusion layer. The co-solvent has a boiling point that is at least as great as that of the solvent, and preferably greater than so that upon heating, the solvent will evaporate before the co-solvent does. The co-solvent may be made from a single composition, such as water or an alcohol, or may be a mixture of various constituents. In addition to applying the ink to the diffusion layer, the method includes heating the catalyst ink to at least partially remove the solvent from the diffusion layer such that the diffusion layer or media becomes a CCDM. In the present context, a CCDM is considered to be an assembly of the diffusion layer and the electrocatalyst and electrolyte irrespective of whether the CCDM is made by an in situ process or from separate layered structures that are subsequently joined together.

Optionally, the electrode formed by the present method is one of an anode and a cathode. In another option, the catalyst ink is heated by an amount sufficient to remove a substantial entirety of the solvent, while in yet another option, at least a portion of the co-solvent remains in the electrode in its un-evaporated (i.e., liquid) form, where the continued presence of un-evaporated co-solvent should reduce the size and concentration of cracking in the formed electrode. Thus, in one form, at least a portion of the co-solvent remains in the electrode until substantially all of the solvent is removed. In another form, at least a portion of the co-solvent remains in the electrode until completion of the heating that is used to dry the diffusion media and remove the solvent. In another option, the electrolyte is made up of a polymer electrolyte (i.e., ionomer). As stated above, the CCDM, which includes the appropriate anode or cathode formed in or affixed to it, may subsequently be joined to the PEM, thereby forming a layered sandwich-like MEA structure. In situations where such joining is achieved by lamination, such lamination would involve, as one example, placing the PEM between an anode CCDM and a cathode CCDM and pressing together under heat and pressure to form the MEA. In one form, the joining of the diffusion layer to the PEM is done once the layer (in the form of a CCDM) has been substantially dried.

According to another aspect of the invention, a method of preparing a diffusion layer for a fuel cell is disclosed. The method includes applying a fluid made up of an electrocatalyst material to a diffusion layer, and heating the fluid to at least partially remove from the prepared diffusion layer a solvent contained in the fluid. The fluid is an ink made up of an electrolyte and a co-solvent, in addition to the aforementioned solvent and electrocatalyst. As with the previous aspect, water may be used in conjunction with or the predominant component of the solvent. The co-solvent has a boiling point that exceeds at least that of the solvent such that upon heating, at least a portion of the co-solvent remains in an un-evaporated liquid state, thereby allowing the diffusion layer or media to become a CCDM.

Optionally, applying the ink may be achieved in a number of ways, including coating, filling, or impregnating a substrate with an ink. In one example, the ink can be applied to the diffusion media devices that apply a predetermined thickness, such as a comma bar or Mayer rod. In another approach, the ink is applied by screen-printing or by a continuous process, such as slot die coating. In another option, the co-solvent has a boiling point that is above at least about 100 degrees Celsius, and more particularly, above about the 139 degrees Celsius boiling point of a solvent such as 1-pentanol. By providing a co-solvent with a higher boiling point than the solvent, the ability of the co-solvent to remain in the diffusion layer at some appreciable level during the critical drying phases is enhanced. In this way, at any given time, the solvent (which for example may be made partially or substantially entirely of water) concentration is low relative to the co-solvent. By way of a non-limiting example, the fluid may include ethanol, water and the co-solvent, such that upon exposure to an elevated temperature environment, the first of these to reach its boiling point would be the ethanol, while the second would be the water, and last the co-solvent. Since the evaporation would in general not take place serially (due, for example, to preferred interactions between the co-solvent and solids), merely picking a co-solvent that has a boiling point above the solvent (for example, 100° Celsius in the case of water) may not be sufficient to ensure an adequate residual quantity of co-solvent in the diffusion layer once the solvent has been removed. Examples of co-solvents that satisfy this criteria are propylene glycol butyl ether (PGBE), ethylene glycol, 1-pentanol, 2,3 butanediol and diacetone alcohol, although it will be appreciated by those skilled in the art that many alcohols that meet the minimum boiling point could be used. In yet another option, the co-solvent comprises broadly up to about sixty five percent by weight of the catalytic ink solution, more particularly up to about thirty percent by weight, and even more particularly up to about ten percent by weight. The present inventors have conducted limited experiments at lower concentrations, including two weight percent and five weight percent, both indicating some measure of performance enhancement, while their investigation into impacts on overall diffusion layer durability are ongoing. In situations where there is a high concentration of certain types of co-solvents in the presence of a water solvent, it may additionally be beneficial to include a relatively low boiling point alcohol in the solvent to improve the miscibility of the co-solvent and the water.

The number and size of any cracks produced on the diffusion media should both be kept to a minimum. To that end, in a preferred option, the width, depth, length and degree of networking of any cracks produced by the present method should be kept small enough so that impacts on durability and performance are reduced or eliminated. In one non-limiting example, the inventors have found that crack widths that do not exceed about 20 microns have been found to promote diffusion media durability by avoiding carbon corrosion, although other sizes for width and other crack dimensions may also be permissible. In addition to crack width, there are several other criteria that could be minimized, including crack depth, length and the degree of networking, where this last is defined by the number of interconnected cracks.

According to yet another aspect of the invention, a fuel cell includes an anode, cathode and membrane disposed between the anode and the cathode. At least a portion of a diffusion media, which may be placed adjacent to or formed as part of the anode or cathode, includes an electrocatalyst that is formed by application of an ink that includes, in addition to the electrocatalyst, a solvent, a co-solvent and an electrolyte. The co-solvent has a boiling point that exceeds at least that of the solvent that may be made from one or more of water, organics or the like. In this way, heating or related curing operations once the ink has been applied to the diffusion media enables at least some of the co-solvent to remain in the electrode ink even after the solvent has been substantially evaporated. As explained above, the continued presence of the co-solvent (or residual products formed due to the introduction of the co-solvent) even after the removal of the solvent improves the resistance of the diffusion media to form cracks, even in situations where the diffusion media is subjected to additional processing or related manufacturing operations. Thus, the inventors believe that, even in situations where the residual co-solvent is low (for example, below 10 percent generally, 5 percent particularly or 1 percent even more particularly) or non-existent after all of the heating and drying associated with the manufacture of the MEA, as long as it is present during the high film stress period that coincides with the condition where the drying process is ongoing, the co-solvent reduces the likelihood of mud crack formation. In the present context, the term “curing” includes those activities that promote a substantially permanent state of cooperation between the ink and the diffusion media. Thus, the presence of the co-solvent permits the ink to be cured, even if not completely dry, so long as it facilitates the desired ink-to-diffusion media combination. As stated elsewhere in this disclosure, retaining a residual amount of co-solvent in a liquid state may be advantageous in that it allows subsequent MEA processing while remaining resistant to mud crack formation in the electrode. By having a higher boiling point than the water or other solvent, the co-solvent improves controllability of the drying process and solvent/solid composition, which in turn leads to minimization of mud cracking.

In one option, the electrolyte is a polymer electrolyte, such as a sulfonated tetrafluorethylene copolymer, which is a Nafion®-like ionomer in the form of a dispersion in an alcohol and water mixture. The polymer electrolyte is an integral part of the electrode as it provides the continuous path for flow of ionized hydrogen. The ionomer provides ionic conductivity in the electrode and helps transport protons from the anode through the membrane to combine with oxygen and electrons on the cathode side to form water. In one form, the electrode and diffusion media are co-formed, such as by the aforementioned application of an electrocatalyst-containing ink to a diffusion media. While such co-forming could be applied to both the anode and the cathode, the present inventors have found such an approach to be especially beneficial in situations where the electrode is the cathode being co-formed. In another option, the electrode and diffusion media comprise separate layers that are subsequently coupled together (such as by lamination) to define an electrode assembly, where in a more particular form, the electrode assembly is a cathode assembly. In yet another option, the co-solvent is selected from the group consisting of PGBE, ethylene glycol, 1-pentanol, 2,3 butanediol and diacetone alcohol, although it will be appreciated by those skilled in the art that any co-solvent (such as those previously discussed) with a boiling point higher than the solvent could be used.

In one form, the fuel cell made according to the present invention may be a stack or related assembly made up of numerous fuel cells. A system that uses such a fuel cell assembly includes numerous fuel cells at least one of which comprises an anode configured to receive a first reactant through an anode diffusion media, a cathode in ion exchange communication with the anode and configured to receive a second reactant through a cathode diffusion media, and a membrane disposed between the anode and the cathode to effect the ion exchange between them. An anode flowpath may be included to fluidly couple the numerous fuel cells of the assembly to a fuel source, while a cathode flowpath may be included to fluidly couple the numerous fuel cells of the assembly to an oxygen source. An electrical circuit may be coupled to the assembly to accept electric current therefrom such that a load (for example, an automotive drivetrain) coupled to the electrical circuit can derive electric power therefrom. As discussed above in conjunction with the previous aspect, at least a portion of one of the electrodes (for example, the cathode) is formed by application of an ink or related fluid that includes an electrocatalyst, solvent, ionomer and co-solvent to a diffusion media. The formulation of the ink is such that the co-solvent has a boiling point that exceeds at least that of the solvent. In this way, upon application to the diffusion media and at least partial drying of the ink, the co-solvent (or compounds formed by its addition) remains in the electrode even after the solvent has been substantially evaporated, helping to minimize crack formation in the electrode.

Optionally, the load comprises a mobile platform, which may more particularly include a vehicle drivetrain. In another form, the mobile platform is a car, truck, van, motorcycle or related automobile that uses the fuel cell assembly as a source of motive power. While it is preferable that the numerous fuel cells are arranged as a stack, it will be appreciated that other forms of assembly or connectivity are also envisioned as being within the scope of the present invention, so long as they cooperate to deliver the desired amount of electrical current to the load.

### BRIEF DESCRIPTION OF THE SEVERAL VIEWS OF THE DRAWINGS

The following detailed description of the present invention can be best understood when read in conjunction with the following drawings, where like structure is indicated with like reference numerals and in which:

FIG. 1 shows a block diagram of a fuel cell system configured for vehicular application;

FIG. 2 is a partially exploded, sectional view of a portion of a fuel cell stack;

FIG. 3A is a top down magnified microscopic image of a cathode manufactured according to the prior art, where excessive mud cracking is in evidence;

FIG. 3B is a magnified cross section microscopic image of the cathode of FIG. 2A at an even higher magnification;

FIG. 3C is a magnified microscopic image of the cathode of FIG. 3A at an even higher magnification;

FIG. 4 is a top down magnified microscopic image of a cathode manufactured according to an aspect of the present invention;

FIG. 5 shows reduction in cell voltages in the stack because of hydrogen crossover through the membrane for various levels of co-solvents in the electrode;

FIG. 6 shows an example of the cathode coating process of the present invention in simplified form, and

FIG. 7 shows a vehicle employing the fuel cell system of the present invention.

### DETAILED DESCRIPTION OF THE PREFERRED EMBODIMENTS

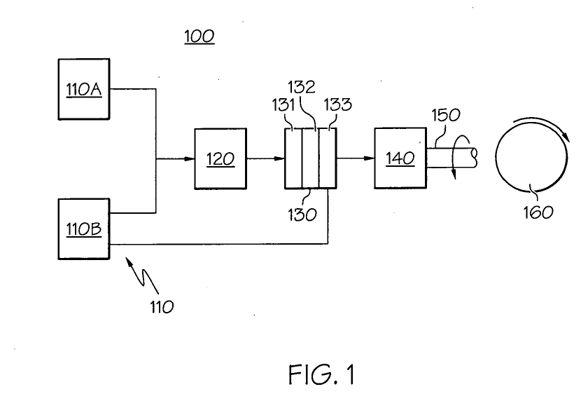

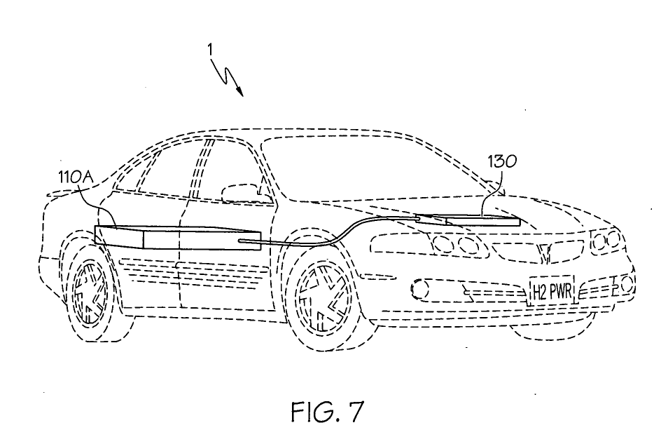

Referring initially to FIGS. 1 and 7, a block diagram highlights the major components of one configuration of a mobile fuel cell system 100 and its use in a mobile application are shown. Referring with particularity to FIG. 1, the system 100 includes a fuel delivery system 100 (made up of fuel source 110A and oxygen source 110B), fuel processing system 120, fuel cell 130, one or more energy storage devices 140, a drivetrain 150 and one or more motive devices 160, shown notionally as a wheel. While the present system 100 is shown for mobile (such as vehicular) applications, it will be appreciated by those skilled in the art that the use of the fuel cell 130 and its ancillary equipment is equally applicable to stationary applications, such as for electric power generators. The energy storage devices 140 can be in the form of one or more batteries, capacitors, electricity converters, or even a motor to convert the electric current coming from the fuel cell 130 into mechanical power such as rotating shaft power that can be used to operate drivetrain 150 and one or more motive devices 160. The fuel processing system 120 may be incorporated to convert a raw fuel, such as methanol into hydrogen or hydrogen-rich fuel for use in fuel cell 130; otherwise, in configurations where the fuel source 110A is already supplying substantially pure hydrogen, the fuel processing system 120 may not be required. Although only a single fuel cell 130 is shown, it will be appreciated by those skilled in the art that fuel cell system 100 (especially those for vehicular and related applications) may be made from a stack of such cells serially connected. Thus, while the term “fuel cell” is generally indicative of a single fuel cell within a larger stack of such cells, it may also be used to define the entire stack. Such usage will be clear, based on the context.

Each fuel cell 130 of a fuel cell stack includes, among other things, an anode 131, cathode 133, and membrane 132 disposed between the anode 131 and cathode 133. Channels (not shown) carry reactants (for example, air in one and gaseous hydrogen in another) to enable the fluid to contact electrocatalysts on the respective electrodes. The ion exchange membrane 132 is placed between each of the anode 131 and cathode 133 to allow the ionized fuel produced at the anode 131 to flow through the membrane 132 while inhibiting the passage of electrical current, which instead is routed through conductive flowfield plates (not shown) to a load (not shown) such that a motor or related current-responsive device may be operated.

Referring with particularity to FIG. 7, a vehicle 1 incorporating a fuel cell system according to the present invention is shown. Fuel cell 130 is fluidly coupled to a fuel supply 110A. While the vehicle 1 is shown notionally as a car, it will be appreciated by those skilled in the art that the use of fuel cell systems in other vehicular forms is also within the scope of the present invention.

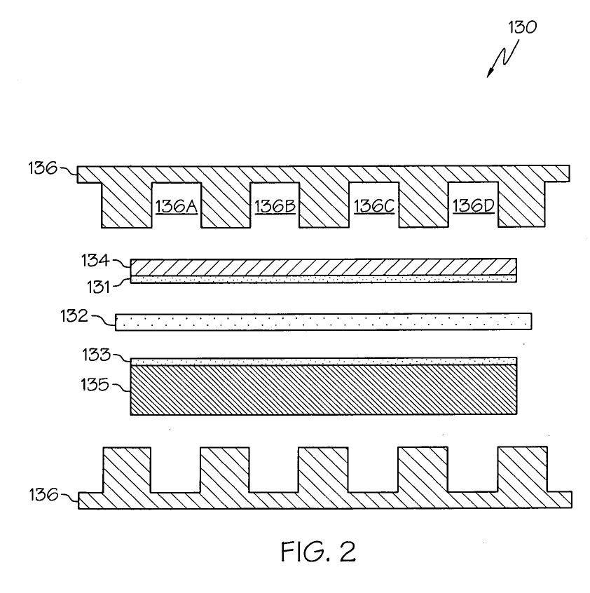

Referring next to FIG. 2, an exploded, sectional view of a portion of a fuel cell stack is shown. The anode 131 and the cathode 133 (both shown notionally as a layer) adjacently face the PEM 132, and each include platinum or a related catalyst dispersed thereon. An anode diffusion media 134 overlays the anode 131, and a cathode diffusion media 135 overlays the cathode 133 such that upon connection of the anode and cathode diffusion media 134 and 135 to the PEM 132, an MEA is formed. Bipolar plates 136 engage the anode and cathode diffusion media 134 and 135, and include reactant gas flow channels 136A, 136B, 136C, 136D and so on. Suitable diffusion media materials may include (but are not limited to) carbon paper, porous graphite, felts, cloths, mesh or other woven or non-woven materials that include some degree of porosity. The thicker cathode diffusion media 135 relative to anode diffusion media 134 makes for a longer, and hence difficult water vapor path, thereby helping to maintain PEM 132 in a sufficiently hydrated state. Nevertheless, it will be appreciated by those skilled in the art that such differences in thickness are not necessary to the operation of fuel cell 130, and may instead by of substantially comparable thickness. Water vapor permeance levels through the cathode diffusion media 135 can be controlled by including different amounts of non-wetting materials, such as polytetrafluoroethylene (PTFE). Levels of PTFE must not be allowed to get too large, otherwise it will reduce the electrical conductivity of the diffusion media 135 to an unacceptable level. As shown, anode 131 forms a part of the anode diffusion media 134, such as by the infusion or related introduction of an ink-based electrocatalyst into the diffusion media 134, although it will be appreciated that other forms of GDM manufacture are possible, such as by affixing a separate porous anode layer (with the appropriate catalytic material) to a diffusion layer. Likewise, the cathode 133 and accompanying cathode diffusion media 135 may be formed in comparable fashion. As will be further appreciated by those skilled in the art, the inclusion of the anode 131 and the cathode 133 to a respective diffusion layer rather than to PEM 132 has the effect of blurring the traditional distinction between an MEA and GDM. Nevertheless, such distinction should be clear from the context of the present disclosure. In one form, the diffusion media 134 and 135 is a teflonated carbon fiber paper. In such form, the paper is pre-coated with a microporous layer (MPL) which is made up of carbon and a fluoropolymer, such as PTFE, fluorinated ethylene propylene (FEP) or the like. The electrode can be coated directly onto the MPL, which should be free of cracks prior to the application of the materials that convert the MPL into the electrode.

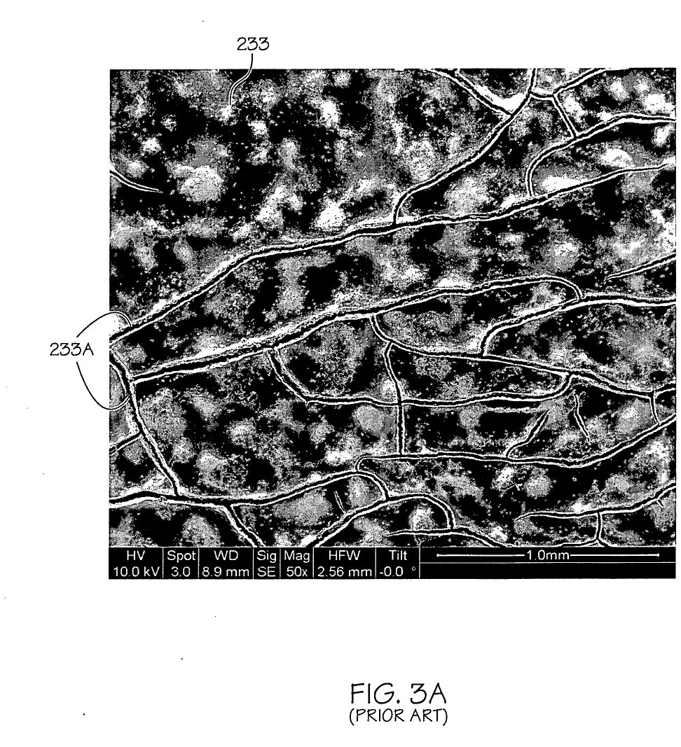

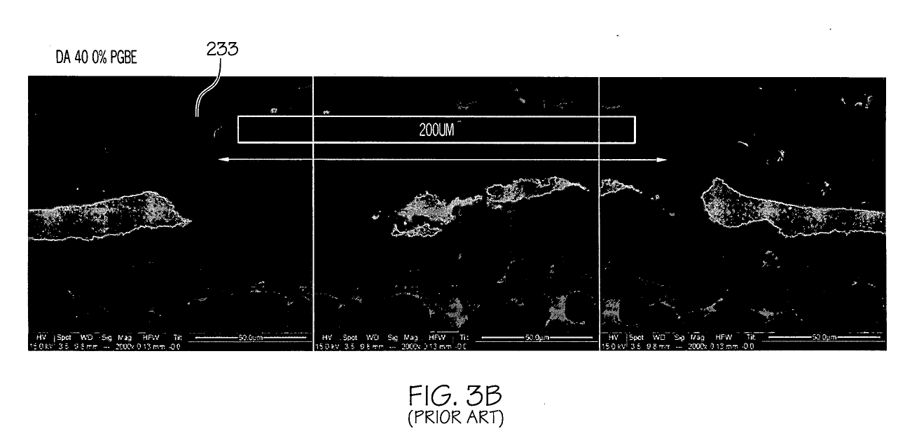

Referring next to FIGS. 3A through 3C, scanning electron microscope images show significant mud cracking 233A on the surface of a cathode 233 manufactured according to the prior art. In such a method, a catalyst-bearing ink is applied to at least a portion of a diffusion media where, in addition to the catalyst (which may make up to almost half of the total amount of the ink by volume, especially in situations where the catalyst includes a carbon or related support), the ink may include a solvent, a binder, porosity-enhancing compounds and ion-exchange material. Typical solvents include water, alcohol and mixtures of both, while the binder may include PTFE, Nafion® or other known material and the porosity-enhancing compounds (including methyl cellulose and surfactants) can be used to form pores. It will be appreciated that Nafion® is an example of an ion-exchange material based on perfluorosulfonic acid (PFSA), and that other suitable equivalents may be used. Alcohol-based solvents are used in electrode inks to better disperse the carbon based catalyst and are more compatible with a PFSA ionomer. Typical electrode inks used for fuel cells contain water and low boiling point alcohols like ethanol and isopropanol, both of which we have used. Numerous problems with membrane degradation result when such extensive mud cracking occurs. For example, the membrane is exposed to stress risers during expansion and contraction of the membrane during humidity cycles. In addition, the part of the membrane adjacent the mud crack is exposed to a different humidity environment than the part underneath the fully-intact catalyst layer. Furthermore, the membrane bending stiffness is reduced in regions adjacent the mud cracks, making the membrane more susceptible to buckling and related failure mechanisms. As can be seen from these figures, many of these cracks are in the millimeter (or multi-millimeter) range in length, are of such length and frequency that they form a significant network of mud cracking.

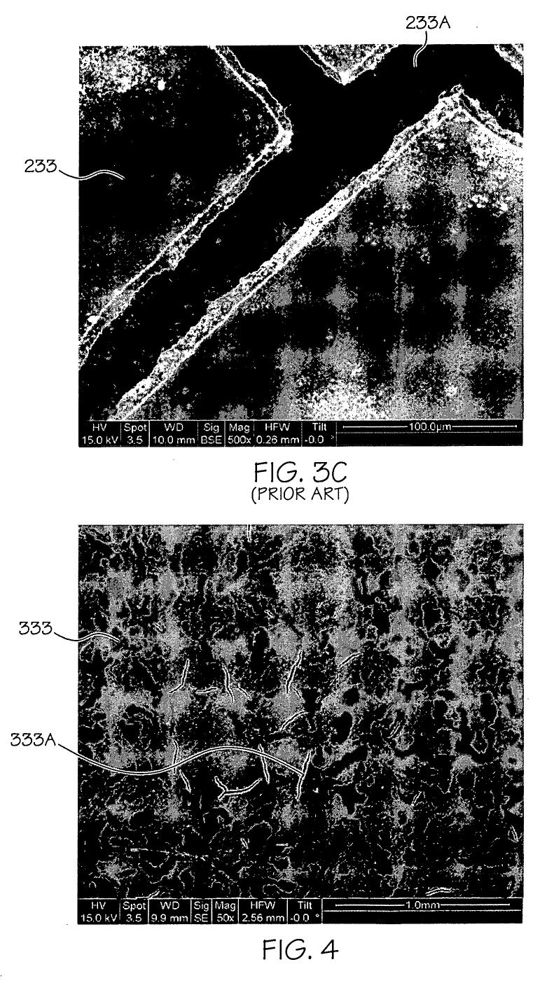

Referring next to FIGS. 4, 5 and 6, evidence of the present inventors' discovery that the use of high boiling point co-solvents significantly reduces the severity of the mud cracks is shown. This high boiling point allows the co-solvent to remain present in the ink during the electrode curing step. In the present context, a co-solvent is considered to have a high boiling point when its boiling point temperature exceeds that of the ink to which it is applied, mixed or otherwise combined. Likewise, the co-solvent is considered to have a high boiling point when the temperature at which it boils exceeds that of the solvent that it is used in conjunction with. In this regard, the absolute temperature at which the co-solvent boils off is not as important as the relative temperature in comparison to the solvent, ink or related fluid used in making the conductive layer. While not willing to be bound to a particular theory, the present inventors believe that the continued presence of the co-solvent through the diffusion media curing step enables an optimal solvent composition during the drying of the film to minimize the occurrence of mud cracks. It is theorized that the presence of the alcohol reduces the relative water amount since the boiling point of the co-solvents are all substantially higher than water. This in turns provides better cohesive strength during the critical drying phase due to better binder and particle interaction. This reduces the likelihood of mud cracking the reduction of which has been correlated to reduced membrane failure in the final fuel cell. The high boiling co-solvent may be added after or during the ink making process. Examples of the co-solvents employed are the aforementioned PGBE, ethylene glycol, 1-pentanol, 2,3 butanediol and diacetone alcohol, although it will be appreciated by those skilled in the art that other co-solvents may be employed. By way of example, the boiling point of PGBE is about 225 degrees Celsius.

Referring with particularity to FIG. 4, in addition to a lower crack density, the length of the cracks that form on a cathode 333 made using a co-solvent according to an aspect of the present invention is significantly reduced compared to the ones shown in FIGS. 3A, 3B and 3C. For example, the longest cracks 333A of FIG. 4 are no more than about 200 to 300 microns, and are insufficient frequency to bridge together to form any significant mud cracking.

Additional processing steps may help ensure a less crack-prone surface. In one form, using proper temperatures is important. For example, the temperature should be sufficient to allow ion-exchange material that is present in the layer of deposited catalyst to flow. In addition, the amount of time needed for compacting depends on the temperature used, where higher temperatures allow for shorter compacting times.

To test a cathode made according to an aspect of the present invention, the inventors constructed a durability short stack. The stack included a reduced number of fuel cells, and was built using electrodes with high and low levels of mud cracks to evaluate membrane durability with different levels of co-solvents resulting in different levels of mud cracks. In this way, different levels of mud cracks can be introduced into the stack with use of different levels of co-solvent such that the MEAs made with the co-solvent, such as that of FIG. 4, visually show an improvement in the electrode quality relative to those that did not include the use of co-solvent.

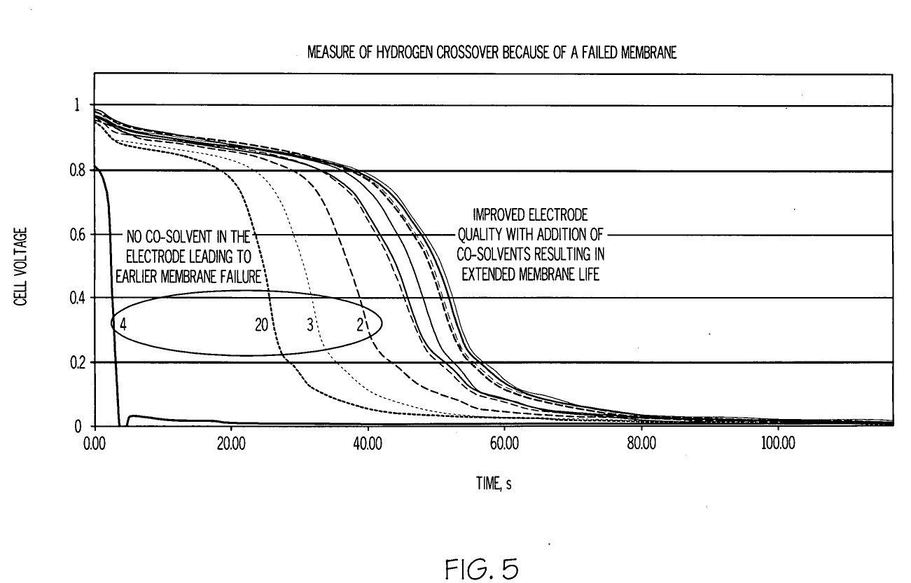

Results of the testing are shown with particularity in FIG. 5, where the less severely cracked electrodes were made using inks that contained PGBE as a co-solvent, while those with high of mud cracks were made without the PGBE. Hydrogen crossover data provides indicia of premature mechanical failure of the membranes that exhibit a high concentration of cracked electrodes. By comparison, those membranes in the same stack which contain lower concentrations of mud cracks in their cathodes have shown extended membrane life. The numbers 4, 20, 3 and 2 inside of the ellipse in the figure indicate the cell numbers in the fuel cell stack that did not have any addition of the co-solvent. As can be clearly seen, these correspond to the samples that were most highly mud cracked, and which resulted in early membrane failures.

The hydrogen crossover suggests that membranes with the poorest electrode quality (i.e., the highest level of mud cracking) fail much earlier in a durability test compared to membranes with lower levels of mud cracks. In the hydrogen take over test, the oxygen flow is cut off and the hydrogen gas is allowed to crossover to the cathode side, thus reducing the overall cell potential. The cells dropping in voltage fastest suggest the highest hydrogen crossover through the membrane, as well as signs of failure because of pinholes in the membrane.

The failure mechanism of the membranes made without a co-solvent can be multifold. For mechanically weak membranes, the relative humidity cycles act as a path or area for such membranes to swell or creep into. This results in formation of pinholes in the membranes, and the consequent hydrogen crossover path from the anode to the cathode results in a loss of voltage. Such high hydrogen crossover and concomitant reduced kinetics makes the membrane difficult or impossible to operate. For chemically unmitigated membranes there is evidence showing that the ionomer itself can degrade in the membrane resulting in cracks in the ionomer layer of a membrane, or of thinning of the membranes. A mud crack leaves the membrane directly exposed to reactants without forming a barrier. Thinning and cracks in the ionomer layers in the membrane can again lead to shorting because of loss of resistance or formation of pinholes.

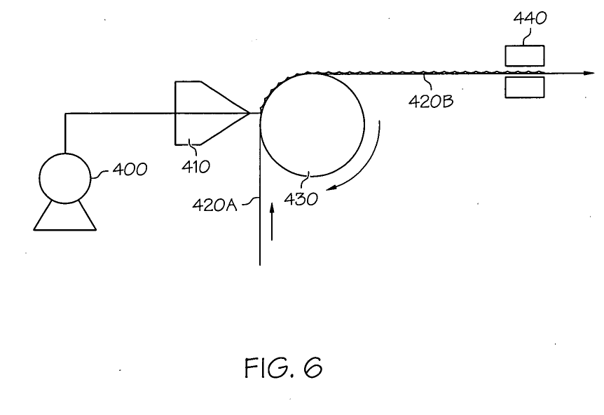

Referring with particularity to FIG. 6, a representative method of infusing an electrocatalytic ink is shown in schematic form. A pump 400 forces the ink to an applicator 410 (shown notionally as a slot die) that is positioned in fluid-dispensing cooperation with a moving diffusion media (preferably in the form of a layer) 420A that passes over a roller 430 or similar conveying mechanism. From there, the ink-impregnated diffusion media 420B passes into a heater or related mechanism 440 to dry the diffusion media 420B by removing at least some of the solvent (and possibly co-solvent) that was used as a carrier for the electrocatalyst and electrolyte. It will be appreciated by those skilled in the art that the relative movement between the applicator 410 and the uncoated diffusion media 420A can be effected by other means, including configurations where the diffusion media 420A remains static and the applicator 410 is moving; either configuration is compatible with the present invention.

While certain representative embodiments and details have been shown for purposes of illustrating the invention, it will be apparent to those skilled in the art that various changes may be made without departing from the scope of the invention, which is defined in the appended claims.

What is claimed is:

1. A method of preparing an electrode assembly for a fuel cell, said method comprising:
applying a catalyst ink comprising an electrocatalyst material, an electrolyte, a solvent, and a co-solvent to a diffusion layer, where said co-solvent has a boiling point that exceeds at least that of said solvent; and
heating the catalyst ink to at least partially remove said solvent from said diffusion layer.

2. The method of claim 1, wherein said heating the catalyst ink to at least partially remove said solvent from said diffusion layer comprises heating the catalyst ink by an amount to remove a substantial entirety of the solvent.

3. The method of claim 1, wherein after said heating, at least a portion of said co-solvent remains in at least a portion of said electrode.

4. The method of claim 1, wherein at least a portion of said co-solvent remains in said electrode until substantially all of said solvent is removed from said electrode.

5. The method of claim 1, wherein at least a portion of said co-solvent remains in said electrode until completion of said heating.

6. The method of claim 1, wherein said electrolyte comprises a polymer electrolyte.

7. The method of claim 1, further comprising joining said electrode to a proton exchange membrane.

8. A method of preparing a diffusion media for a fuel cell, said method comprising:
applying a catalyst ink comprising an electrocatalyst material, an electrolyte, a solvent and a co-solvent to a diffusion layer, where said co-solvent has a boiling point that exceeds at least that of said solvent; and
heating the catalyst ink to at least partially remove said solvent from said diffusion layer.

9. The method of claim 8, wherein said co-solvent has a boiling point that is above at least about 100 degrees Celsius.

10. The method of claim 9, wherein said co-solvent has a boiling point that is above at least about 139 degrees Celsius.

11. The method of claim 9, wherein said co-solvent comprises alcohol.

12. The method of claim 9, wherein said co-solvent is selected from the group consisting of propylene glycol butyl ether, ethylene glycol, 1-pentanol, 2,3 butanediol and diacetone alcohol.

13. The method of claim 8, wherein said co-solvent comprises a mixture.

14. The method of claim 8, wherein said co-solvent comprises up to sixty five percent by weight of said catalytic ink solution.

15. The method of claim 14, wherein said co-solvent comprises up to ten percent by weight of said catalytic ink solution.

16. The method of claim 8, wherein said heating comprises leaving at least a portion of said co-solvent that is applied to said diffusion layer in an un-evaporated state even after said heating.

17. The method of claim 8, wherein said solvent comprises at least one of water and an alcohol.

18. A fuel cell comprising:
an anode configured to receive a first reactant through an anode diffusion media;
a cathode in ion exchange communication with said anode, said cathode configured to receive a second reactant through a cathode diffusion media where at least a portion of at least one of said anode diffusion media and said cathode diffusion media includes an electrocatalyst formed by application of an ink comprising said electrocatalyst, an electrolyte, a solvent and a co-solvent with a boiling point that exceeds that of said solvent such that upon curing said ink once applied to said at least one diffusion media, at least a portion of said co-solvent remains on said diffusion media even after said solvent has been substantially evaporated; and
a membrane disposed between said anode and said cathode to effect said ion exchange.

19. The fuel cell of claim 18, wherein said cathode and said cathode diffusion media are co-formed.

20. The fuel cell of claim 18, wherein said cathode and said cathode diffusion media comprise separate layers that are joined together to define a cathode assembly.

21. The fuel cell of claim 18, wherein said co-solvent is selected from the group consisting of propylene glycol butyl ether, ethylene glycol, 1-pentanol, 2,3 butanediol and diacetone alcohol.

22. The fuel cell of claim 18, further comprising a plurality of said fuel cells arranged as a fuel cell assembly.

23. The fuel cell assembly of claim 22, further comprising a system powered at least in part by said fuel cell assembly, said system comprising:
an anode flowpath configured to couple said plurality of fuel cells to a fuel source;
a cathode flowpath configured to couple said plurality of fuel cells to an oxygen source; and
an electrical circuit coupled to said assembly to accept said electric current therefrom; and
a load coupled to said electrical circuit.

24. The system of claim 23, wherein said load comprises a mobile platform.

25. The system of claim 24, wherein said mobile platform comprises a vehicle drivetrain.

26. The system of claim 24, wherein said mobile platform comprises an automobile with said assembly comprising a source of motive power.
